(19) United States
(12) Patent Application Publication
(10) Pub. No.: US 2009/0282337 A1
(43) Pub. Date: Nov. 12, 2009

(54) SYSTEM AND METHOD FOR MANAGEMENT AND PRESENTATION OF AUDIOVISUAL CONTENT

(75) Inventors: Michael Douglas Tilley, Troy, MI (US); Joseph Alonzo Sanders, Roswell, GA (US); Timothy William Rochon, Rochester Hills, MI (US); Kumar Bhogaraju, Bangalore (IN)

Correspondence Address: BROOKS KUSHMAN P.C., 1000 TOWN CENTER, TWENTY-SECOND FLOOR, SOUTHFIELD, MI, 48075, US

(73) Assignee: Michael Douglas Tilley, Troy, MI (US)

(21) Appl. No.: 12/119,110

(22) Filed: May 12, 2008

(51) Int. Cl. G06F 3/00; G06F 15/173

(52) U.S. Cl. 715/719

(57) ABSTRACT

Several embodiments of the present invention take the form of a system and method for management and presentation of audiovisual content via a global computer network. The system and method includes a database disposed on the network and an interface in electrical communication with the database.

### BACKGROUND

1. Field

Embodiments of the present invention relate to a system and method for management and presentation of audiovisual content via a global computer network.

2. Background

Coaches and managers affiliated with amateur and professional athletic programs require significant amounts of information about various aspects of athletic events. For example, coaches may evaluate information about opposing players and teams to develop game plans to be executed by his players. Managers and coaches may also have a need to identify prospective talent to be added to the program. Each of these exercises requires a significant investment of time and money to view, create and evaluate reports that provide the necessary information.

Creation and development of customized software to track this information is an inefficient use of the program's time, experience and money. Additionally, the benefits of such a program are frequently limited in scope to a distinct group of people within the single entity. Further, existing software programs do not provide a level of functionality or financial benefit to many amateur athletic programs. It would be advantageous to provide a system and method for management and presentation of audiovisual content via a global computer network that addresses the current limitations existing in the marketplace.

### DRAWINGS

Embodiments of the present invention described herein are recited with particularity in the appended claims. However, other features will become more apparent, and the embodiments may be best understood by referring to the following detailed description in conjunction with the accompanying drawings, in which:

FIG. 1 illustrates a schematic view of an environment in which embodiments of the present invention may operate;

FIG. 2 illustrates a flow diagram depicting a method for editing video footage from a sports game according to an embodiment of the present invention;

FIG. 3 illustrates a screenshot of an interface for capturing video footage from a sports game according to an embodiment of the present invention;

FIG. 4 illustrates a screenshot of an interface for splitting the captured sports-game video footage into multiple video clips according to an embodiment of the present invention;

FIGS. 5A-5B illustrate screenshots of an interface for tagging a video clip with metadata relating to the sports play shown in the video clip according to an embodiment of the present invention;

FIGS. 6A-6B illustrate screenshots of an interface for generating a play corresponding to a video clip according to an embodiment of the present invention;

FIG. 7 illustrates a screenshot of an interface for generating a compilation of video clips according to an embodiment of the present invention;

FIG. 8 illustrates a schematic view of an alternate environment in which embodiments of the present invention may operate;

FIG. 9 illustrates a screenshot of a web-based interface for displaying stored sports video clips;

FIG. 10 illustrates a screenshot of a web-based interface for generating a video clip compilation according to an embodiment of the present invention;

FIG. 11 illustrates a screenshot of a web-based interface for generating a play compilation according to an embodiment of the present invention; and

FIG. 12 illustrates a screenshot of a web-based interface for sharing information with one or more users via a wide-area network according to an embodiment of the present invention.

### DETAILED DESCRIPTION

The present invention is not limited to the specific embodiments described below. Rather, the described embodiments are exemplary of the invention, which may be embodied in various and alternative forms. Therefore, specific details should not be interpreted as limiting, but as a representative basis for teaching a skilled artisan to employ the present invention.

As used in this section, and unless otherwise indicated, the term “embodiment” refers to “embodiment of the present invention,” the articles “a”, “an”, and “the” comprise plural referents, and all numerical quantities are modified by the word “about”.

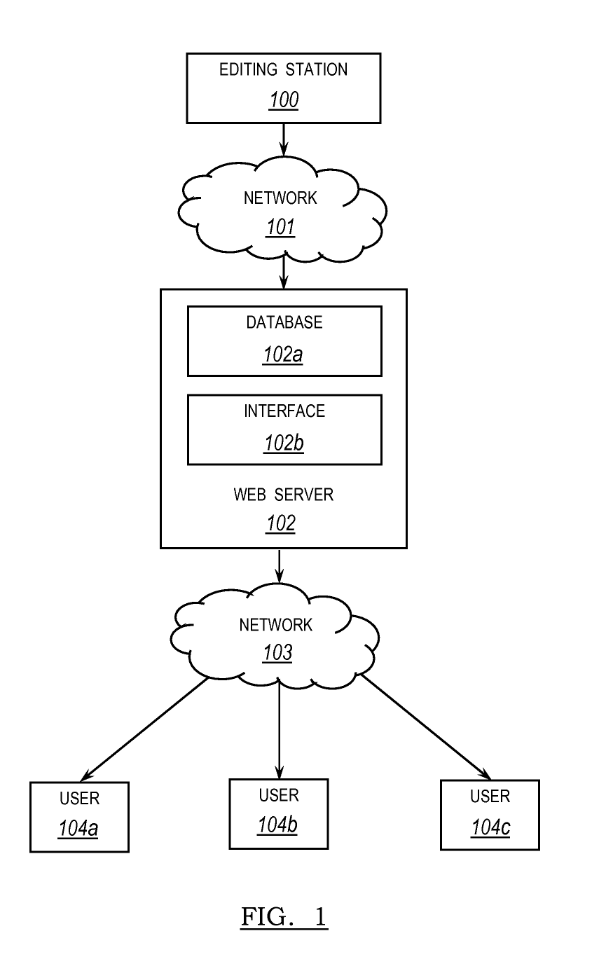

A system and method for management and presentation of audiovisual content in a global computer network is disclosed and illustrated. FIG. 1 illustrates a simplified schematic view of an environment in which embodiments of the present invention may operate. As shown, an editing station 100 is in electrical communication with a web server 102 via a network 101. The web server 102 may include and allow access to a database 102a and a graphical user interface 102b. Multiple users, generally referenced by numeral 104, may access information stored by the database 102a through the interface 102b and via a global computer network 103. The global computer network 103 may include various connections such as the Internet, or another suitable connection arrangement such as a wide area network or a local area network.

Audiovisual content of an event, such as a sporting event, may be recorded via one or more recording apparatus, such as a moving or still picture camera device or the like. The resultant audiovisual content may contain moving and/or still video and audio for use in the system. Where recording audiovisual content results in multiple content feeds, each feed may, for example, represent a different view of the sporting event. The audiovisual content includes video data, which may be in any analog video format (i.e., NTSC, PAL, SECAM, etc.) or any digital video format (e.g., MPEG2, etc.). The content may be recorded to a suitable medium (i.e., an analog tape, hard drive, non-volatile memory, digital video disc, etc.).

The editing station 100, shown in FIG. 1, may be generally configured to receive, convert, and perform a variety of editing functions on the audiovisual content. The editing station is configured with suitable hardware and/or software for performing these functions. For example, a general purpose computer (not shown) may have hardware configured to interface with a video camera (e.g., a USB port). The computer may also have software for receiving, converting, and storing the video feed or alternate configurations for performing the receiving, converting, and storing functions. While the following disclosure refers to a single video feed for clarity, embodiments of the present invention also contemplate receiving and editing multiple video feeds.

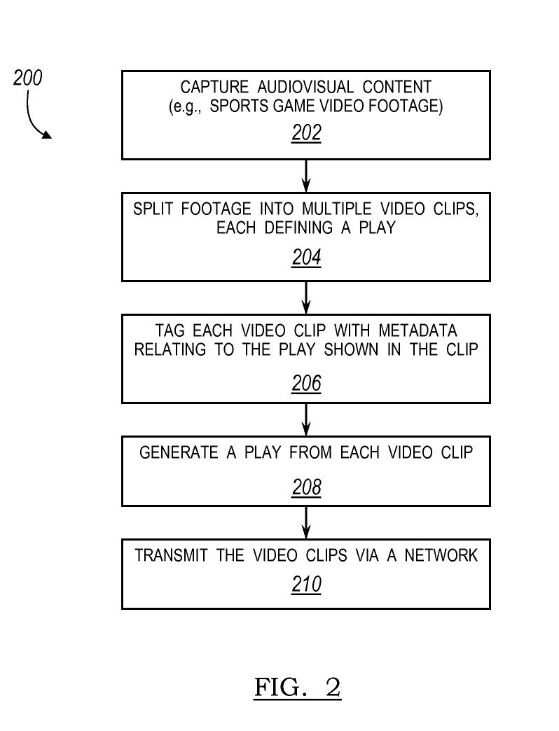

According to an embodiment of the present invention, the editing station 100 includes a computer program configured to operate on the type of general-purpose computer mentioned above. Several embodiments of the present invention generally allow for editing, tagging, and providing such audiovisual content to a plurality of users via a user interface. The computer program may be configured to carry out a method of receiving, converting, and editing the audiovisual content of a sporting event. FIG. 2 shows a flow diagram 200 illustrating this system and method.

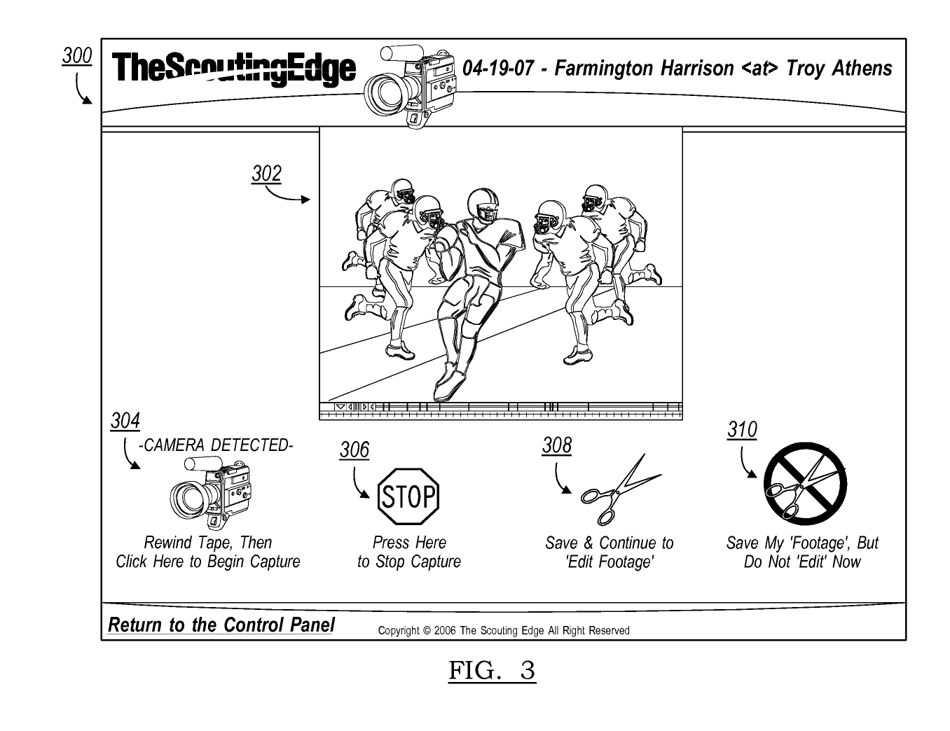

FIGS. 3-6 show screenshots illustrating various functions of this system and method. To explain each step in the flow diagram 200, reference is made to FIGS. 3-6. In step 202, the computer program may facilitate receiving or capturing the audiovisual content, and if necessary converting the content to another format. The audiovisual content may be stored to a computer medium (i.e., a hard drive, a non-volatile memory, etc.) once received. FIG. 3 illustrates a receiving interface 300 of the computer program, more specifically a receiving interface engaged in the receipt and conversion of audiovisual content. The video portion of the audiovisual content may be displayed via a video player element 302. In another embodiment, a recording medium in a video camera, generally referenced by numeral 304, supplies the audiovisual content to the system.

Several options 306-308 enable user control of the capture of the audiovisual content. The option labeled 306 enables the user to rewind the recording medium and begin capturing the video feed from an earlier data point. The option 306 allows for selectively stopping the video-feed capture. The option 312 of the system allows the audiovisual content to be saved, by, for example, storing the content to a recording medium such as a hard drive. Option 310 permits the user to edit the feed of the audiovisual content. Options 310 and 312 are normally disabled during the audiovisual content feed capture. Once the capture commences, or is stopped by the user, these options are enabled.

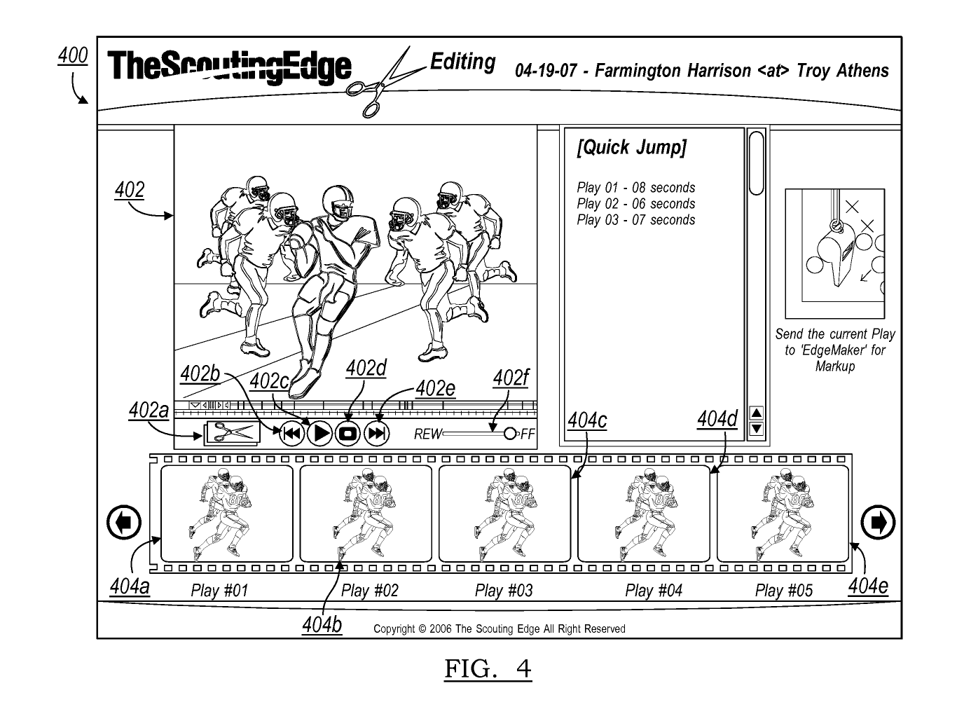

In step 204, the computer program facilitates splitting the captured audiovisual content into multiple clips or elements. In an embodiment of the present invention, the splitting operations may be such that each clip or element corresponds to a play in the sporting event. FIG. 4 illustrates a screenshot of the computer program, more specifically a splitting interface through which a user may split the audiovisual content into multiple clips or elements. A video player element 402 displays the active video portion of the audiovisual content, which may be the video feed or a video clip split from the audiovisual content feed. The player 402 may include several associated controls 402a-402f to allow a user to manipulate the position of the active video or splitting the active video into multiple video clips as discussed herein.

Other exemplary controls may be incorporated to allow for manipulation of the audiovisual content feed. For example, the control 402c plays the active video, while controls 402b, 402e rewind and fast-forward the content, while control 402f enables a user to select a data point in the video. When a user selects the control 402c, the recording of a new clip begins. Control 402a commences the recording of that clip to the system. In the screenshot referenced generally by numeral 400, several video clips (generally 404) have been split from the video feed and are sequentially listed. A user can select one of these video clips 404, and then select a playmaker icon 406 to generate a play for the associated video clip.

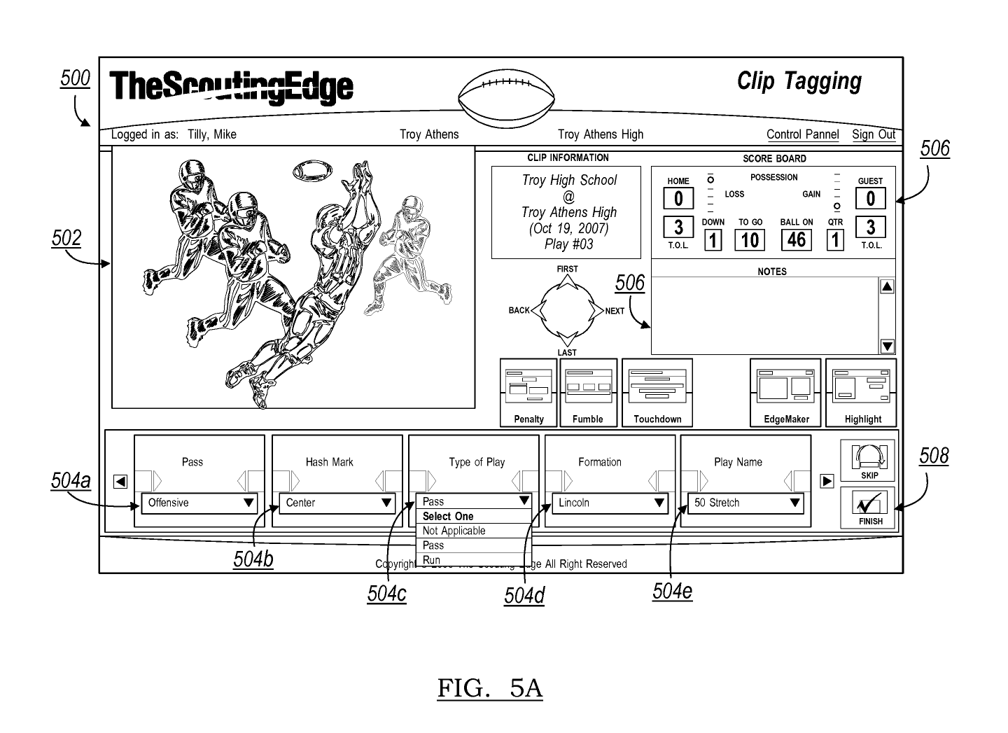

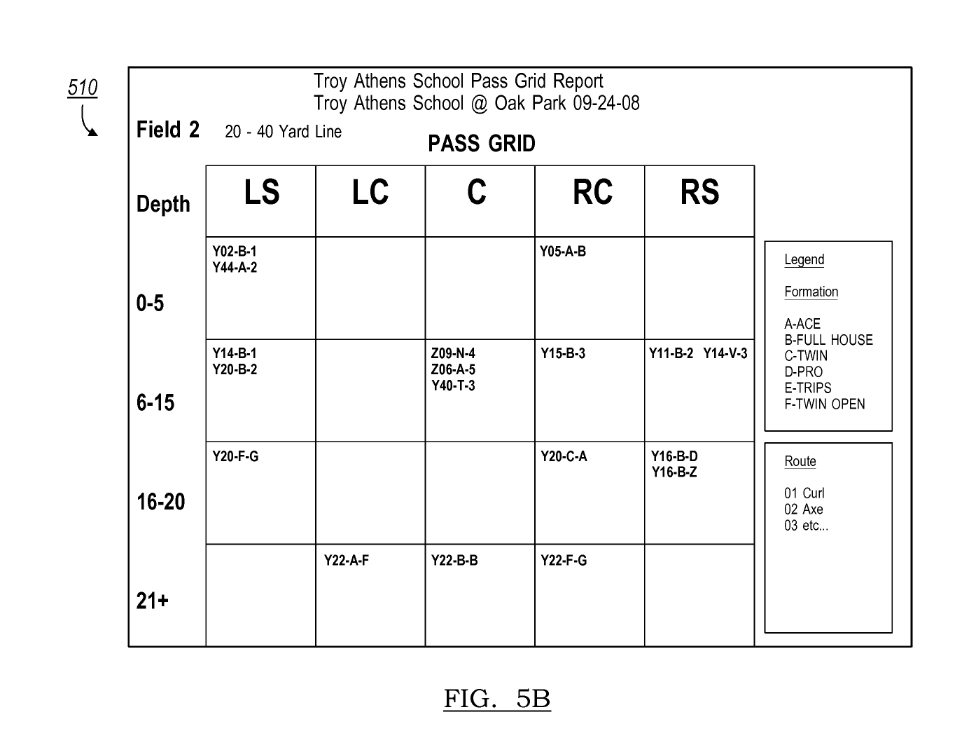

In step 206, the computer program facilitates tagging, or associating a clip of audiovisual content with supporting metadata. In an embodiment, the metadata associated with a given clip of audiovisual content relates to action in a sporting event shown in the clip. The sporting event may relate to a variety of sports including, but not limited to, football, soccer, basketball, baseball, track-and-field, and hockey. FIG. 5A shows a screenshot 500 of the tagging feature of the computer program, more specifically a tagging interface through which a user may tag a given clip. The tagging interface includes a video player element 502 configured to play the clip and associated controls (not shown) for manipulating the position and timing of the clip. Such controls may also enable a user to change properties associated with the clip including, but not limited, to the name, play speed and sound level of the clip.

In an exemplary embodiment shown in the Figures, the video player element 502 displays a football game. The user may manipulate various other controls, generally referenced by numeral 504, for tagging information to the particular play. The tagged information may relate to the specific play shown in the clip. In the screenshot 500, the controls 504 relate to such parameters as the team 504a (i.e., offense or defense), the hash marker location 504b, the type of play 504c, the formation 504d, and the play name 504e. Notably, in several embodiments, each control 504a-504e may operate in a cascading fashion. Accordingly, each control may have a number of selectable options. Selecting one of the options in a given control may repopulate other controls with different options. For example, in the shown embodiment, the option “Offensive” has been selected in the control 504a. This may populate control 504c with the options “Not Applicable,” “Pass,” and “Run.” However, if another option had been selected in control 504b, for example “Defensive”, control 504c may be populated with other options.

As shown, a user can tag custom comments to a given video clip via the text box 506. In an embodiment, the computer program is configured to calculate several parameters, such as the game score, the down, and the yard marker, through the user-inputted metadata. In the shown embodiment, such calculated information is shown in a scoreboard region 508.

It is understood that a numerous aspects of a particular event can be configured for tagging and tracking utilizing the present system and method. The shown tagging interface has various other controls. Notably, the shown clip-tagging information is not meant to be limiting. A skilled artisan will recognize that a variety of other information may be relevant for clip tagging. Furthermore, the information may vary based on the type of sport depicted by the clip.

Once a user tags the video clip, he or she may select the control 508 to finalize the video-clip tagging process. In turn, the computer program may save the tagged information or metadata to a storage medium. The metadata or tagged information may be saved with the video clip or separate from it.

FIG. 5B shows a report that may be generated from a tagged play according to an embodiment of the present invention. In the shown embodiment, the report is a “pass grid report” and accordingly relates to a passing play. Of course, the type of report generated may correspond to the type of play. In the shown report 510, each entry in the vertical column corresponds to the field depth (e.g., between the 6 yard line and the 15 yard line), and each entry in the horizontal row corresponds to the field position (i.e., left-center, center, right-center). Each box depicts a play formation, a play route, and a number of yards gained/lost from running the given play. In this manner, the report 510 presents information that may indicate the play tendencies of a team at different field depths and/or field positions.

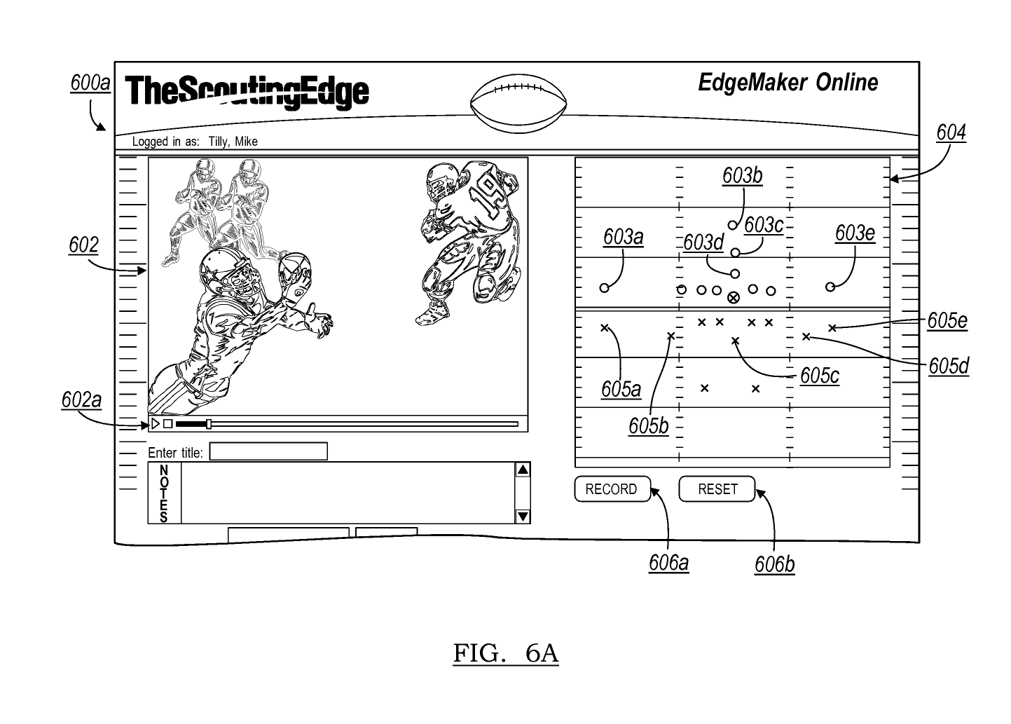

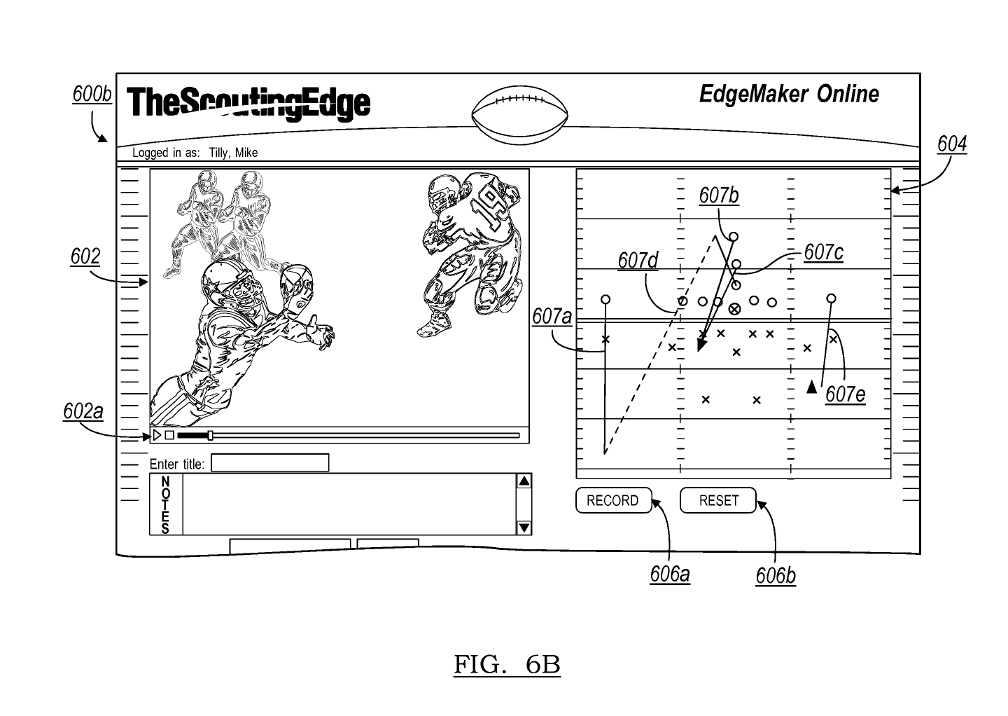

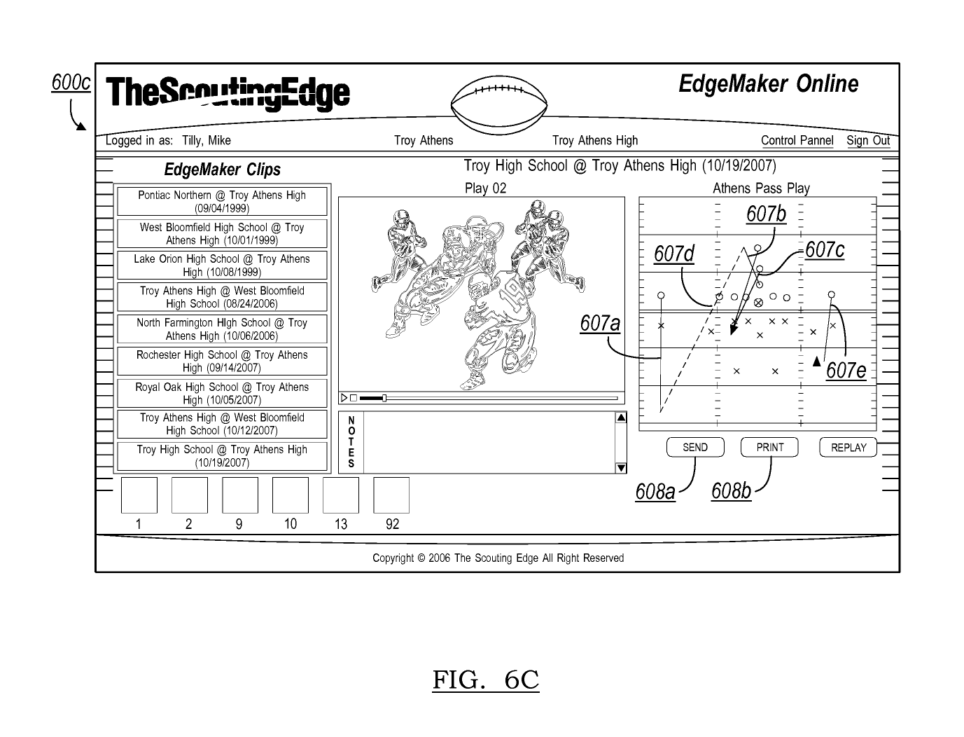

In step 208, the computer program facilitates generating a play associated with a given video clip. FIGS. 6A-6C show screenshots 600a-600c of the computer program, more specifically a playmaker interface through which a user may generate a graphical representation of a play corresponding to a video clip. As shown, the playmaker interface includes a video player portion 602 configured to play a video clip and associated controls 602a for manipulating the position of the video clip. The interface also includes an interactive playmaker portion 604 along with controls 606a-606b for generating a play in the playmaker portion 604.

The playmaker portion 604 displays multiple elements therein—several “O-shaped” elements, several of which are generally referenced as 603a-603e, and several “X-shaped” elements, several of which are generally referenced as 605a-605e. Each of the O-shaped element 603a-603e corresponds to a respective player on one team; each of the X-shaped elements 605 corresponds to a respective player on the other team. As noted, the shown playmaker portion 604 is interactive. More specifically, a user may interactively move each element 603, 605 within the region of the playmaker portion 604. For example, a user can select a given element with a mouse cursor, click-and-hold a mouse button, and move the cursor within the playmaker portion 604. The computer program may keep track of the path along which a given element moves.

In an exemplary embodiment, a user starts a video clip via the respective control 602a and then selects the “record” control 606a to capture the play. The user may then watch the video clip and move each element according to the respective player's movement. Once finished, the user can select the “record” control 606a again to stop recording. If the user desires to start over, he or she can select the “reset” control 606b. A generated play is shown within the playmaker portion 604 in FIG. 6B with arrows 607a-607e extending from respective O-shaped elements 603a-603e. Each arrow may show the path selected by the user for the given element. Once the play has been generated, the user can perform a variety of functions including, but not limited to sending or printing the generated play via respective controls 608a, 608b in FIG. 6C.

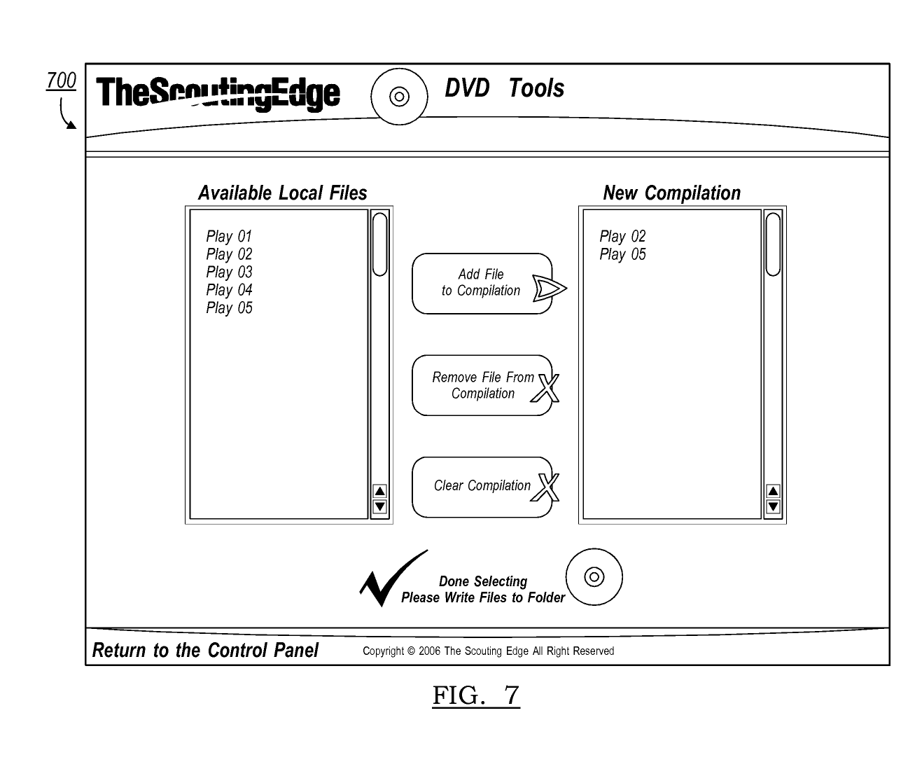

In another embodiment, the computer program may enable a user to create a compilation of selected video clips. FIG. 7 shows a screenshot 700 of the computer program, more specifically a compilation interface for generating a digital video disc (DVD) from selected video clips. Notably, a compilation can be created in a number of other ways. Suitable alternatives include, but are not limited to, a flash video, a slideshow presentation, and the like. In the shown compilation interface 700, two of the five available files have been added to a new compilation.

In step 210, the computer program may transmit the video clips, along with the tagged information and the play corresponding to each clip, to the web server 102, which stores the net data to a database 102a. Once stored, the data may be accessed and used with one or more applications, including, but not limited to, reporting, video clip sharing, sports team management, and recruiting. Several of these functions are described in the following disclosure.

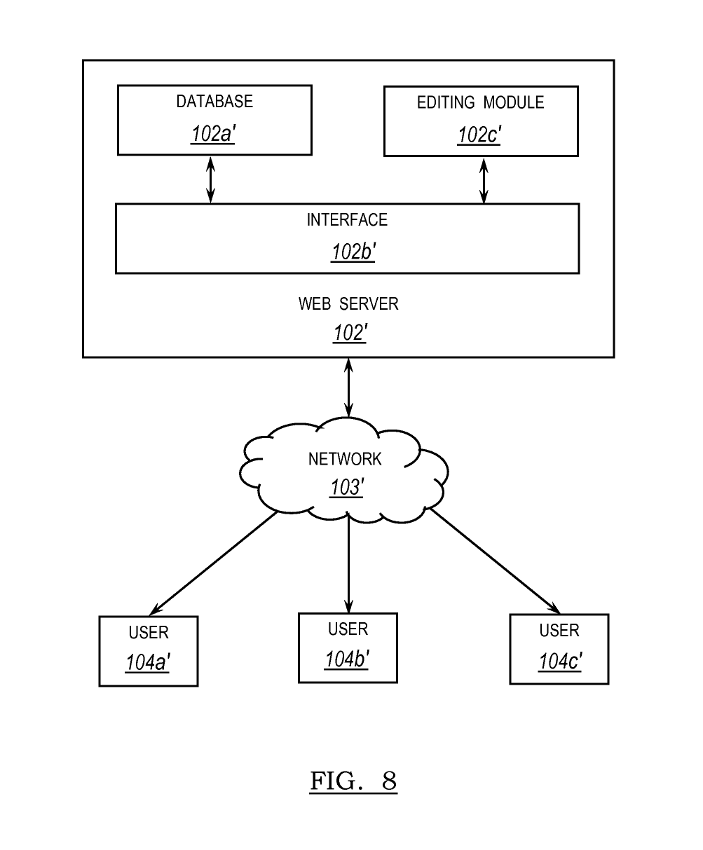

Notably, one or more of the steps 204-210 may instead be carried out via the web server 102. As shown in FIG. 8, the web server 102′ includes a database 102a′, a web interface 102b′, and an editing module 102c′. Multiple users may access the data in the database through the web interface 102b′ via a network 101′. For example, the web server 102 may provide a web site, and a user might access the provided web site via an internet browser. Moreover, users 104a′ that have adequate permission from the web server 102′ can modify the data in the database 102a′ via the editing module 102c′. Accordingly, a video feed can be uploaded to the web server 102′. A user 104 can then split the video feed into multiple video clips, tag each video clip, and generate a play from each video clip. This allows for video editing in a distributed manner.

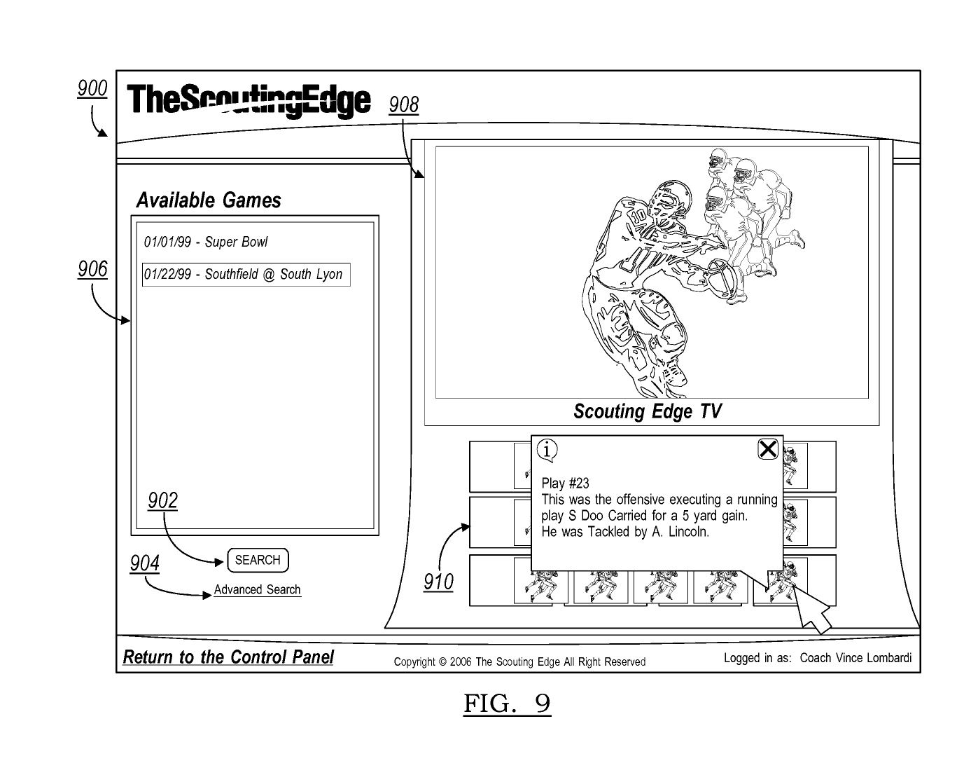

In an embodiment of the present invention, a user 104 may watch selected video clips through a web browser via the web server 102. FIG. 9 shows a screenshot 900 illustrating a viewing interface through which a user 104 may select and watch streaming video clips. Notably, the web server 102 is configured to allow a user to search for video clips—any suitable search technique may be used, for example, a keyword search, a Boolean search, or the like. Accordingly, a user may search for video clips stored to the database 102a. In the shown viewing interface 900, a user may search stored video clips via the controls 902 and 904. Links to selected video clips are displayed in the list region 906. The video clip corresponding to each may be viewed in the video player 908. Streaming video technology for playing videos via wide area networks is known in the art. The video player 908 may play a video clip using any suitable streaming video technology, including Java VXC, Flash, or the like.

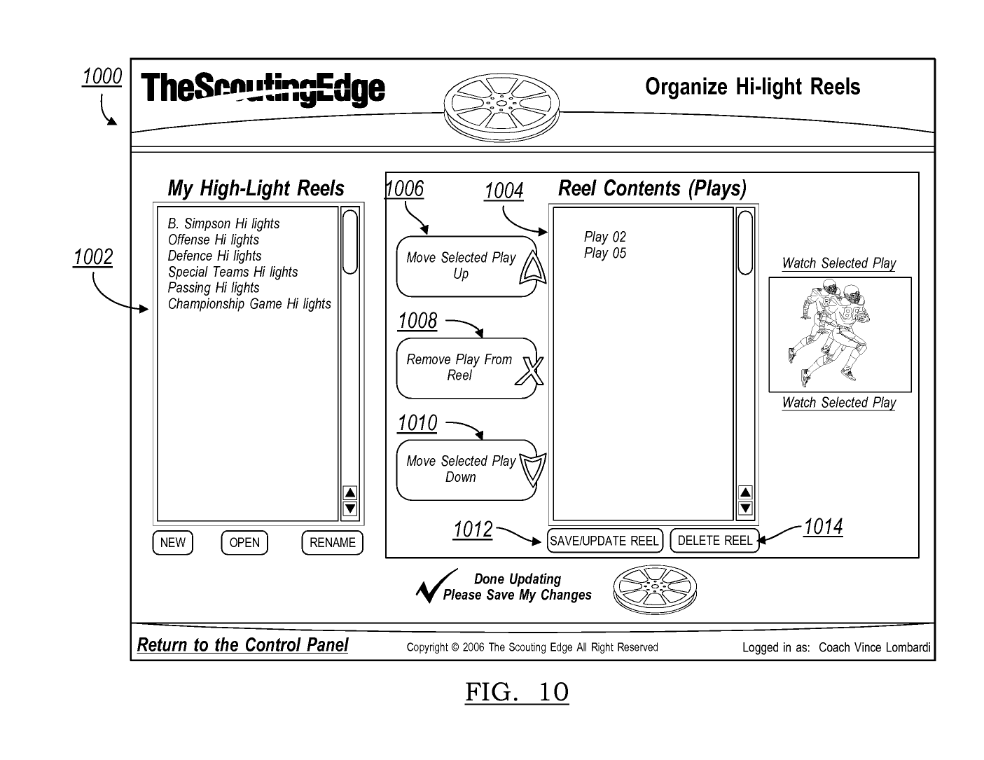

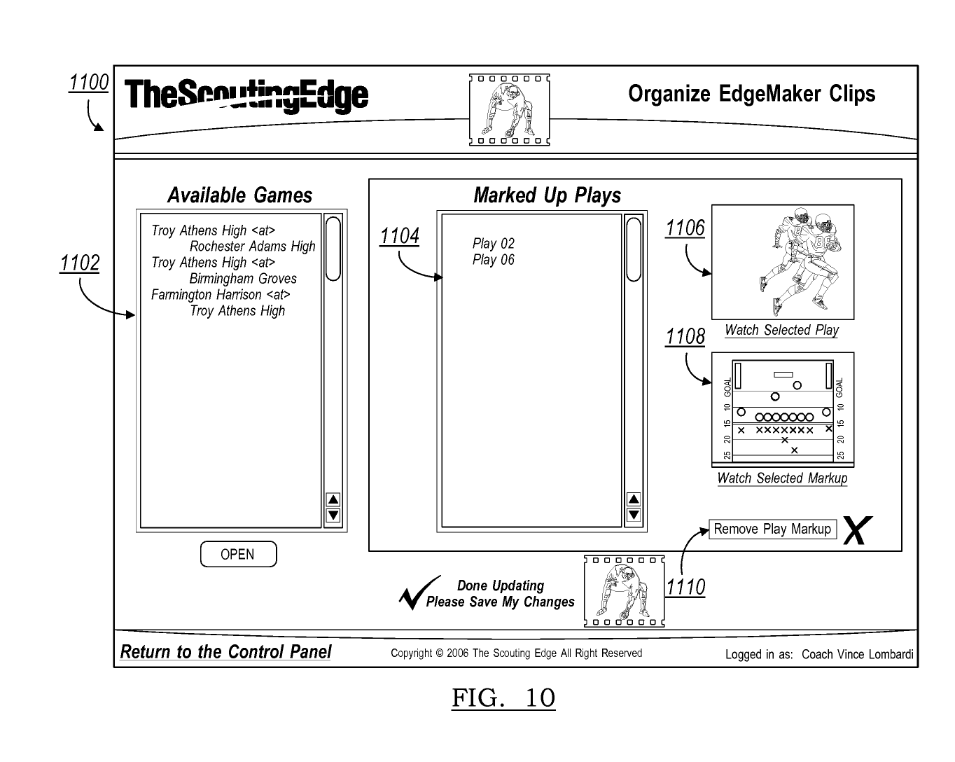

FIG. 10 shows a screenshot 1000 illustrating a highlight reel interface 1000 through which a user 104 may choose one or more stored video clips to share a compilation of the video clips with one or more other users. A listbox 1002 shows several preloaded highlight reels: B. Simpson Highlights, Offense Highlights, Defense Highlights, Special Teams Highlights, Passing Highlights, and Championship Highlights. Each highlight reel may have been preconfigured, for example, by searching or browsing stored video clips and adding selected video clips to define a given reel. For example, a given reel may include clips showing defensive plays for a given team. A selected highlight reel displays in another listbox 1004. A user can use controls 1006-1014 to edit the highlight reel. A video player 1016 enables the user to watch a selected video clip in the listbox 1004. The interface 1000 may have other controls (not shown) to search, add, or edit video clips.

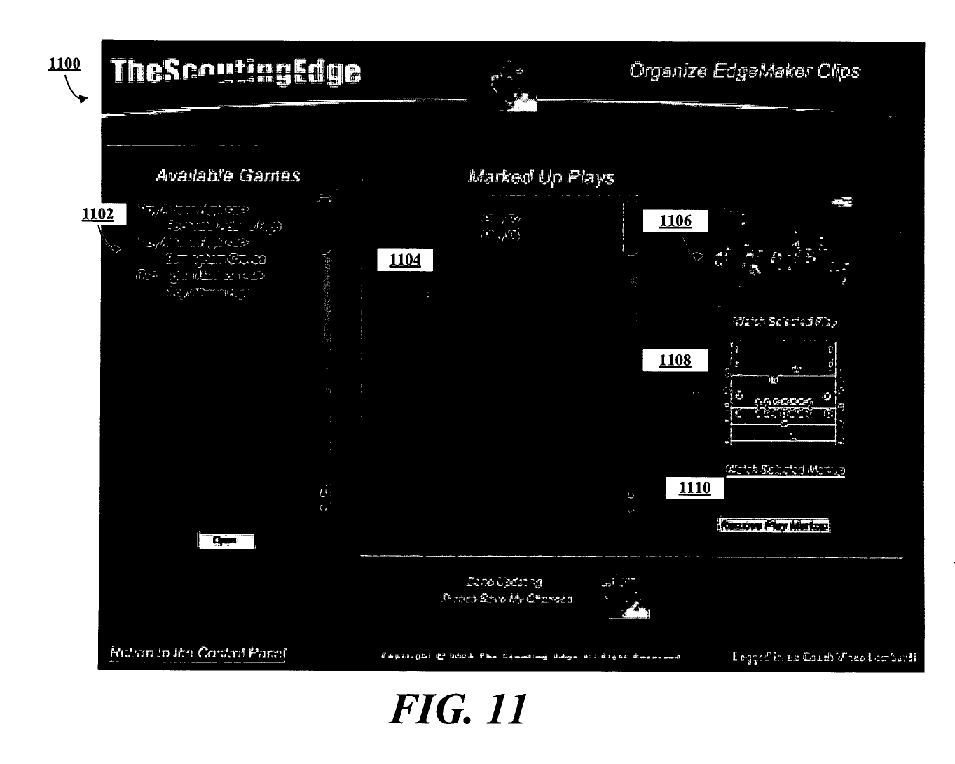

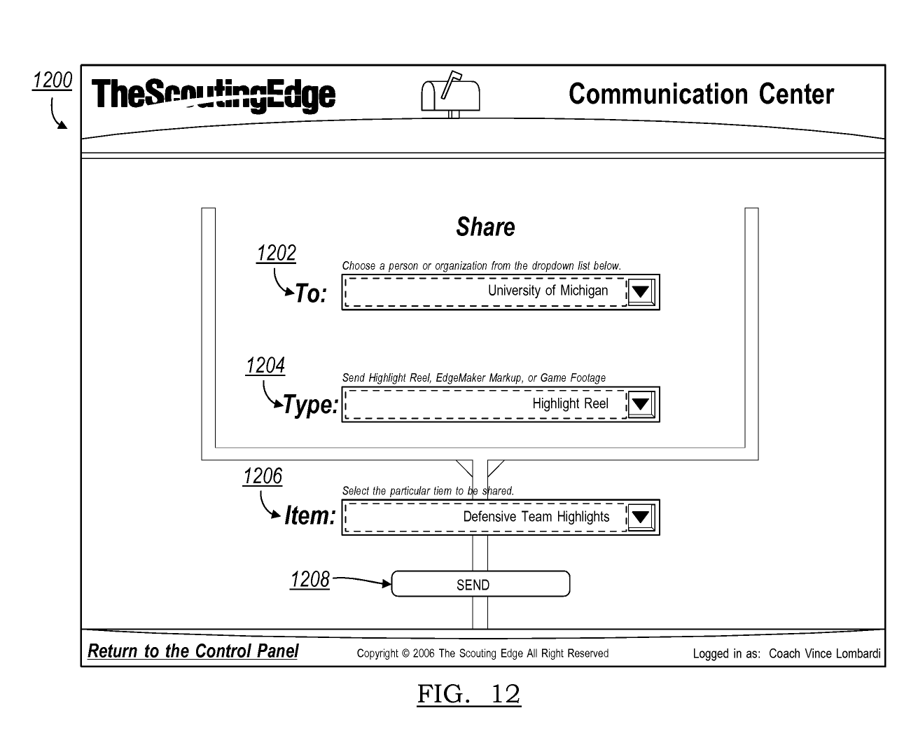

FIG. 11 shows a screenshot 1100 illustrating a play compilation interface through which a user 104 may choose one or more stored plays to share a compilation of the plays with one or more users. Here, the user 104 may select a pre-configured list of plays in a listbox 1102 and edit the list in another listbox 1104. A video player 1106 enables a user to watch the video clip corresponding to the selected play, which is displayed in the play viewer 1108. The control 1110 allows the user to remove a selected play. The play compilation interface 1100 may have other controls (not shown) for adding plays or editing selected plays.

In at least one embodiment of the present invention, a user 104 can share a compilation of video clips (“highlight reel”), a compilation of plays (“edgemaker markup”), video footage from a game, or a combination of these. Several drop-down menus are shown. The menu 1202 corresponds to the desired recipient(s). Each entry may link to a list of one or more correspondence addresses, such as e-mail addresses, phone numbers, or the like. In the shown screenshot, these entries are pre-configured. However, the interface may be configured to allow a user to manually enter one or more correspondence addresses (e.g., e-mail addresses). The menu 1204 corresponds to the type of information a user desired to send. This menu 1204, like menu 1202, may be configured to allow a user to manually select one or more types of information (e.g., both highlight reel and edgemaker markup). The menu 1206 corresponds to a selected item a user wishes to share. Like menus 1202 and 1204, menu 1206 may have options to allow a user to define a customized item (e.g. a combination of video clips and plays).

Once the user selects items in each menu 1202-1206, he or she can select the control 1208 to send the desired information to the desired user(s). In one embodiment of the present invention, the web server sends a link to the correspondence address of each desired user. For example, the web server may send an e-mail with an embedded link to each user. In another embodiment, the web server sends a text message to each user's phone number. The text message may have an embedded link to the shared information. A skilled artisan will recognize other electronic methods for communicating the desired information to the one or more users. Furthermore, a variety of other information may be sent to the users.

While embodiments of the invention have been illustrated and described, it is not intended that these embodiments illustrate and describe all possible forms of the invention. Rather, the words used in the specification are words of description rather than limitation, and various changes may be made without departing from the spirit and scope of the invention.

What is claimed is:

1. A system for management and presentation of audiovisual content, the system comprising:
a database disposed on a computer network including a stored video clip of a sports play and stored metadata corresponding to the video clip, the stored metadata including a sports play object corresponding to the video clip;
an interface in electrical communication with the database on the network, the interface configured to receive data from a plurality of users via the network and transmit the received data to the database;
wherein the system configured to
generate a compilation of video clips including at least the stored video clip responsive to user input via the interface, and
present a compilation of information allowing the user to access the generated compilation via the network.

2. The system of claim 1, wherein the system is further configured to generate a sports play compilation including at least the stored sports play object responsive to user input via the interface.

3. The system of claim 2, wherein the system is further configured to electronically transmit a link to an electronic address of a user via a wide area network, wherein the link references the generated sports play compilation and enables the user to access the generated compilation via the wide area network.

4. The system of claim 1 wherein the electronic address is an e-mail address.

5. The system of claim 1 wherein the electronic address is a phone number and the link is electronically transmitted as part of a text message.

6. The system of claim 1 wherein the sports play object is a play generated by a user, and wherein the sports play object corresponds to the sports play in the corresponding stored video clip.

7. The system of claim 1 wherein the interface is configured to display the stored video clip to a user responsive to input received from the user via the wide area network.

8. A method for generating a sports play compilation, the method comprising:
receiving a sports clip;
defining a sports play parameter;
receiving user input corresponding to the sports play parameter and the received sports clip;
associating the user input with the received sports clip;
providing a browsing interface for browsing a listing of sports clips, the listing including at least the received sports clip and another sports clip;
receiving user input corresponding to a selection of at least the received sports clip and the other sports clip; and
generating a sports play compilation from at least the received sports clip and the other sports clip.

9. The method of claim 8, wherein the step of receiving a sports clip comprises:
providing a user interface different from the web user interface; and
receiving the sports clip via the user interface.

10. The method of claim 8, wherein the sports play parameter is selected from the group consisting of: an offensive play, a defensive play, and a special teams play.

11. The method of claim 8, further comprising enabling a user to share the sports play compilation.

12. The method of claim 11, wherein the step of enabling a user to share the sports play compilation comprises:
providing a sharing interface for enabling a user to share the sports play compilation;
receiving user input via the sharing interface, the user input defining at least one electronic recipient address;
sending a link corresponding to the sports play compilation to each recipient address; and
displaying the sports play compilation via a viewing interface responsive to a user selecting the link.

13. The method of claim 12, wherein the recipient address is an e-mail address.

14. The method of claim 12, wherein the recipient address is a phone number, and the link is sent to each phone number as a text message.

15. The method of claim 12, wherein the viewing interface is a web interface.

16. A system for creating and sharing a sports play compilation, the system comprising:
a database including a defined sports play parameter, multiple sports clips, and, multiple metadata portions, each metadata portion corresponding to the defined sports play parameter and a respective one of the sports clips; and
a web interface;
wherein the system is configured to:
display a browsing interface including a listing of the sports clips;
display a selection interface for allowing a user to select one or more of the sports clips in the listing;
generate a sports play compilation from selected sports clips; and
enable a user to share the sports play compilation via the web interface.

17. A user interface for designing a sports play, the user interface comprising:
a video portion configured to play a video clip upon activation; and
an interactive playmaker portion configured to activate in response to activation of the video portion, wherein upon activation of the playmaker portion a user can interactively design a play therein corresponding to the playing video clip.

18. The user interface of claim 17 wherein the playmaker portion comprises a first set of interactive elements corresponding to a first sports team and a second set of interactive elements corresponding to a second sports team.

19. The user interface of claim 18 wherein each element has an initial position, when the playmaker portion is activated, a user may reposition a selected one of the interactive elements to a final position along a path, and the user interface is configured to store points of the path.

20. A system for designing and sharing a sports play, the system comprising:
a database including a video clip stored thereto; and
a user interface including a video portion and an interactive playmaker portion, wherein the video portion is configured to play a video clip upon activation, the playmaker portion is configured to activate in response to the activation of the video portion, and upon activation of the playmaker portion a user can interactively design a play therein corresponding to the playing video clip;
wherein the system is configured to:
receive user input via the web interface, the user input defining a selection of the stored video clip;
play the stored video clip in the video portion together with activating the video portion, thereby activating the playmaker portion;
receive user input via the web interface, the user input defining a sports play designed in the playmaker interface; and
enable a user to share the designed sports play.
